(19) United States
(12) Patent Application Publication
(10) Pub. No.: US 2004/0027247 A1
(43) Pub. Date: Feb. 12, 2004

(54) Restraining sleeve apparatus for prevention of the spread of germs, disease, and infection

(76) Inventor: Alton R. Pittman, Bronson, FL (US)

Correspondence Address: FOWLER WHITE BOGGS BANKER, P.A., 501 E. KENNEDY BOULEVARD, SUITE 1700, TAMPA, FL, 33602, US

(21) Appl. No.: 10/213,813

(22) Filed: Aug. 7, 2002

(51) Int. Cl. G08B 23/00

(52) U.S. Cl. 340/573.7

(57) ABSTRACT

An apparatus that warns the wearer when he attempts to touch his hand to his face, eyes, nose, or mouth for the purpose of preventing the spread of germs, disease, and infection is provided. The apparatus comprises a self-fitted or adjustable “sleeve” worn on the elbow, a position-sensing device, and an alerting device. The device also comprises a battery or other power source for the position-sensing and alerting devices.

### FIELD OF THE INVENTION

The present invention relates to an apparatus worn on the elbow, much like a brace or splint, that alerts the wearer when he attempts to touch his face, eyes, mouth, or nose with his hand. The device's alerting mechanism serves as a reminder for the wearer to avoid such contact to prevent the spread of germs, disease, and infection, at least until the wearer has an opportunity to wash or disinfect his hands.

### BACKGROUND OF THE INVENTION

Many infectious diseases or viruses are spread by coming in contact with infectious germs and then transferring the germs from the hands to the eyes, mouth, or nose. Infectious germs can exist on surfaces such as doorknobs, hand towels, restroom facilities, and telephones for several days. A person infected with the cold or flu can pass germs by shaking hands, even if that person has used a tissue.

The U.S. Center for Disease Control and Protection (CDC) says that the spread of many infectious diseases can be prevented by washing hands to eliminate germs that have been picked up from other people or surfaces. In fact, the CDC says that hand washing is the most important means of preventing the spread of infection. However, people do not wash their hands as often as they think they do, and there is great potential for naturally touching the face area without even being aware of the action.

The CDC estimates that there are 62 million cases of the common cold annually, resulting in 45 million days of lost productivity (1996 data). Hepatitis A, which can be spread through contact with stool from an infected person, results in almost 5,000 deaths and 17,000 cases of infection annually (1999 data). An apparatus that alerts the wearer that he is raising his hand to his face can stem these statistics, and prevent the spread of other infectious diseases as well.

Prior art in the prevention of the spread of infectious diseases by hand to face contact includes apparatuses that create a physical barrier, such as a mask or gloves. U.S. Pat. No. 6,213,125 by Reese, et al. describes a shield and mask configured to fit over the nose and mouth of the wearer for use by medical personnel. U.S. Pat. No. 5,975,083 by Henderson, Jr. discloses a method and apparatus for dispensing serrated polymeric, adhesive-backed material for covering the hands of persons wanting to avoid contamination during handling of any object previously handled by others, such as door handles, restroom towel dispensers, and salad bar utensils.

Prior art, also in the medical field, includes a number of splints, braces, and the like which purpose is to restrain use of an injured limb during recovery or rehabilitation. U.S. Pat. No. 5,484,389 by Stark et al. discloses an instrumented orthopedic device and method of use, whereby the device comprises fixed or moveable struts connected to a hinge mechanism that restrain and fix the limb at a predetermined angle. The device also comprises an attached stress sensor, controller, and memory storage device. The Stark device measures and records the stress created by movement or attempted movement of the injured limb.

Prior art similar in effect to the proposed invention, although not in purpose, is disclosed in U.S. Pat. No. 4,965,553 by Delbondi, II, et al. The Delbondi device comprises a wristband, a position sensor, and an audible alarm to warn the wearer when his hand is near his mouth. The disclosed purpose for this wristband device is to assist persons who wish to limit food intake and count calories or who wish to stop smoking.

While the above-described prior art devices may be effective for the disclosed uses, these devices are not always practicable, nor are they discreet. For example, a person attending a social function who must shake another's hand would be quite obvious to, if not socially shunned by, others by donning a mask or gloves. Similarly, an instrumented brace as disclosed by Stark et al. or a wristband as disclosed by Delbondi, II, et al. lacks discreetness. But a person wearing the restraining sleeve apparatus, unbeknownst to those around him, would be discreetly alerted upon attempting to touch his face, and he can restrain himself until it is convenient for him to wash his hands and kill any bacteria or germs.

The present invention meets a need for disease prevention in social or public settings and overcomes the disadvantages of prior art.

### BRIEF SUMMARY OF THE INVENTION

The apparatus of the present invention can reduce the spread of infection and overcome the lack of discreetness in the prior art. The present invention provides a “sleeve” worn over the elbow. The sleeve is of a comfortable, flexible, lightweight polymeric or other material, either self-fitted or adjustable, fastened by any manner of conventional fastening devices. For example, an adjustable sleeve can be fastened by one or more hooks and eyes, by straps and buckles, by snaps, by loop and hook material (e.g. Velcro), or any other fastener. A vast number of fastening devices are well known to those skilled in the art and any manner of fastening devices may be incorporated in the present invention in alternate embodiments. The sleeve material may be lined with any commercially available fabric such as felt or fleece or any other material to improve the wearer's comfort.

The apparatus comprises a position-sensing device, such as a commercially available gravity or mercury switch. Another potential sensing device is a three-axis sensor, which detects changes in altitude. A number of position-sensing devices are well known to those skilled in the art and any manner of such device may be incorporated in the present invention in alternate embodiments.

The apparatus comprises an alerting device such as a vibrator or buzzer or any other alerting device to warn the wearer that his hand is approaching his face. A number of alerting devices are well known to those skilled in the art and any manner of such device may be incorporated in the present invention in alternate embodiments. The apparatus also comprises a power source for the position-sensing and alerting devices such as a dry cell or other battery or any other power source as may be well known to those skilled in the art and which may be incorporated in the present invention in alternate embodiments.

The apparatus comprises a housing device containing the position sensing device, the alerting device, and the power source and also comprises an on-off switch than allows the wearer to enable or disable the flow of current from the power source.

It is an object of the present invention to provide either a self-fitted or adjustable sleeve that functions to prevent the spread of germs, disease, and infection by alerting the wearer that his hand is approaching his face.

It is an object of the present invention to provide an apparatus that comprises a position-sensing device and an alerting device along with a power source for such devices, and further comprises an on-off switch and a housing device containing the position sensing device, the alerting device, and the power source.

It is an object of the present invention to provide an apparatus that can be worn discreetly, thereby overcoming the disadvantages of prior art disease prevention devices that operate by creating a physical barrier to the spread of germs, disease, and infection.

It should be appreciated that a number of configurations and alternative embodiments may be employed in the present invention, and that the invention is not limited to any particular sleeve material, lining material, position-sensing device, power source, or alerting device.

The accompanying drawings, which are incorporated in and constitute a part of this specification, illustrate alternate embodiments of the invention and, together with the description, serve to explain the principles of the invention.

### BRIEF DESCRIPTION OF THE DRAWINGS

The following figures set forth the preferred embodiment of the present invention:

FIG. 1 is a perspective view of the present invention showing the sleeve and housing for the position-sensing device, the alerting device, and the power source.

FIG. 2 is an axial plan view of the apparatus of FIG. 1.

FIG. 3 is a top plan view of the sleeve of FIG. 1.

FIG. 4 is a perspective view of the preferred embodiment the sleeve of FIG. 3

FIG. 5 is a top plan sectional view of the housing of FIG. 1 for the position-sensing device, the alarm device, and the power source.

FIG. 6 is a perspective view of an alternate embodiment of the sleeve of FIG. 3 with fasteners.

FIG. 7 is a schematic diagram of the elements of the apparatus.

### DETAILED DESCRIPTION OF THE PREFERRED EMBODIMENT

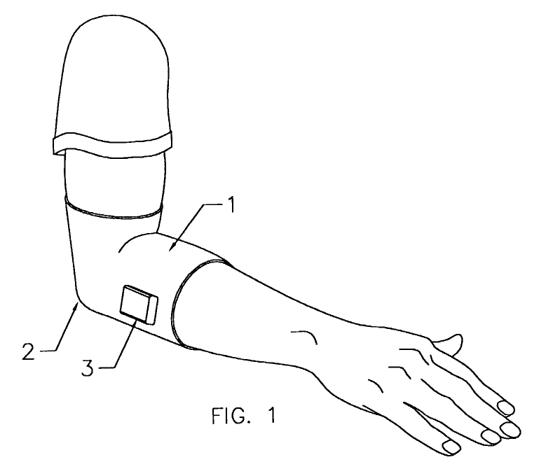

FIG. 1 is a perspective view of the present invention showing a sleeve (1) worn over a person's elbow (2) and a housing device (3) for the position-sensing device, the alarm device, and the power source. The apparatus is worn to discreetly alert the wearer that his hand is approaching his face so he can restrain himself until it is convenient for him to wash his hands and kill any bacteria or germs.

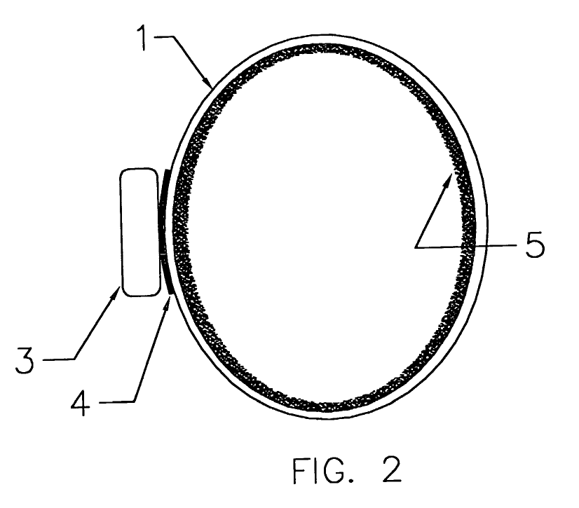

FIG. 2 is an axial plan view of the apparatus of FIG. 1. Housing device (3) is affixed to sleeve (1) by hook and loop (Velcro) fastening material (4) or any other suitable fastening material. Sleeve (1) is lined with any commercially available fabric (5) such as felt or fleece or any other material to improve the wearer's comfort.

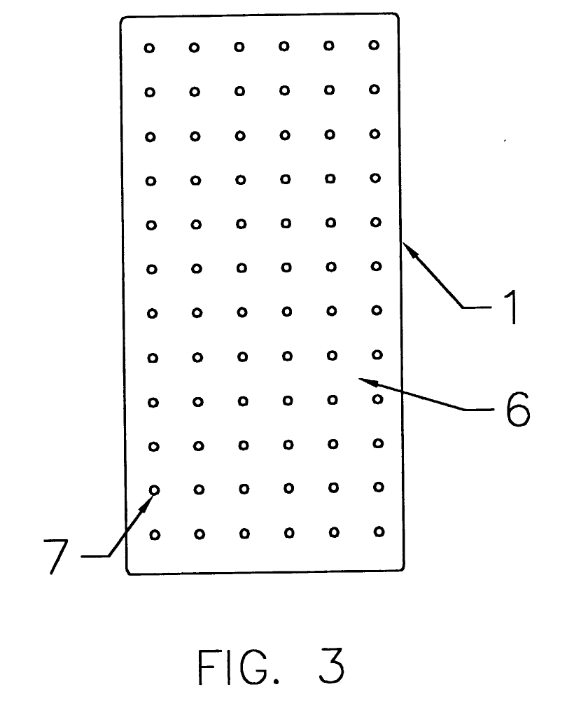

FIG. 3 is a top plan view of the sleeve (1). The sleeve (1) is of a comfortable, flexible, lightweight polymeric or other suitable material (6) that may be perforated (7) for comfort.

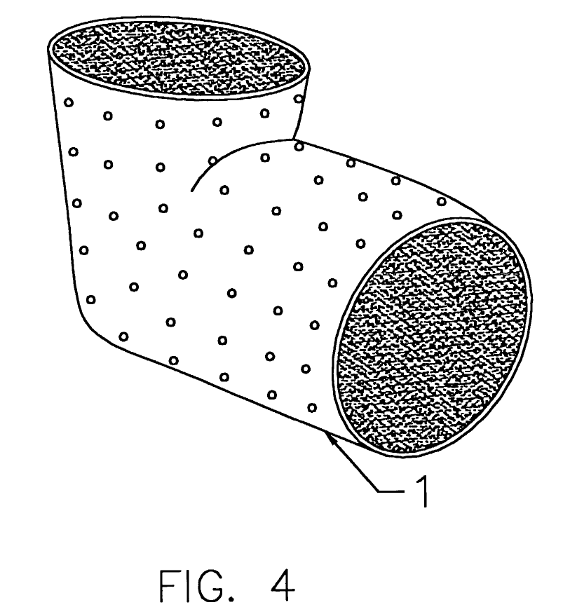

FIG. 4 is a perspective view of the preferred embodiment the sleeve (1) that is self-fitted, and which may be made in various sizes or made of a material that will stretch and conform to the wearer's arm.

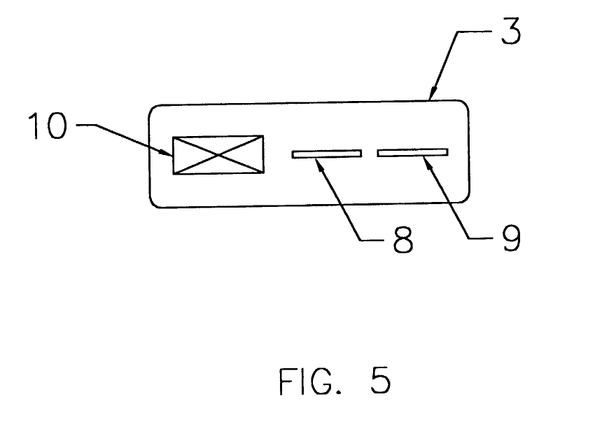

FIG. 5 is a top plan sectional view of the housing device (3) for the position-sensing device (8), the alerting device (9), and the power source (10). The position-sensing device (8) can be a commercially available gravity or mercury switch, or a three-axis sensor, which detects changes in altitude, or any other suitable position-sensing device. The alerting device (9) may comprise a vibrator or buzzer or any other alerting device to warn the wearer that his hand is approaching his face. The power source (10) for the position-sensing and alerting devices can be a dry cell or other battery or any other power source that is commercially available.

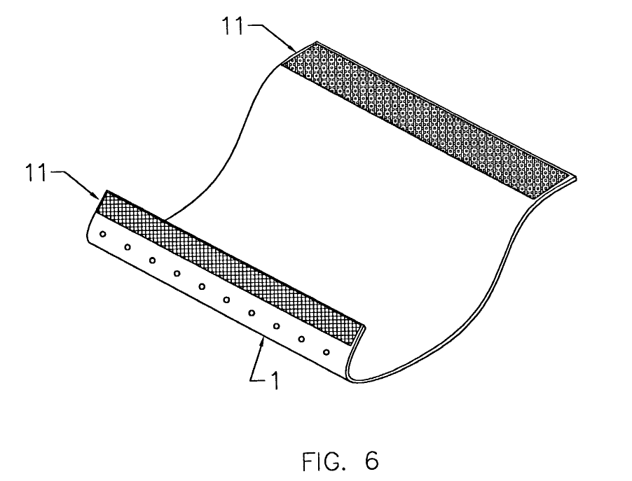

FIG. 6 is a perspective view of an alternate embodiment of the sleeve (1) of FIG. 3 with fasteners (11) for adjustability. The fasteners can consist of any conventional fastening devices in any number as necessary to be effective. For example, an adjustable sleeve can be fastened by one or more hooks and eyes, by straps and buckles, by snaps, by loop and hook material (e.g. Velcro), or any other fastener.

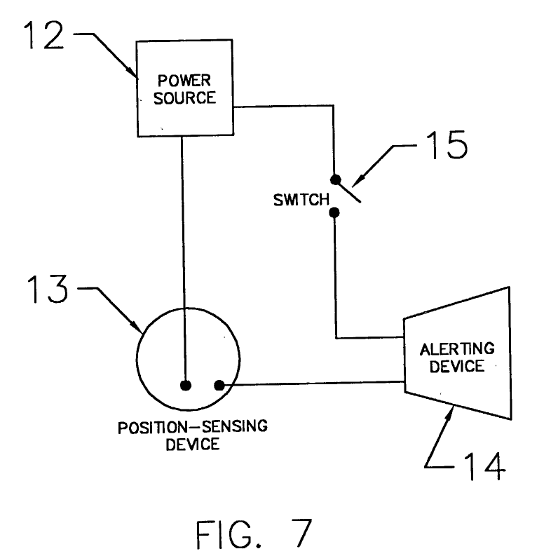

FIG. 7 is a schematic diagram. The power source (12) supplies current to the position sensing device (13) and the alerting device (14). When the position-sensing device (13) is tripped or turned on by the wearer's elbow reaching a pre-determined angle or altitude, which is set taking into account the wearer's right or left-handedness, the circuit is complete and the alerting device (14) emits an audible or vibration signal to the wearer that his hand is approaching his face. When the wearer moves his hand from his face and his elbow position falls outside the pre-determined angle or altitude, the circuit is broken and the alerting device (14) is turned off. The on-off switch (15) allows the wearer to enable or disable the device.

What is claimed is:

1. An apparatus for preventing the spread of germs, disease, and infection by alerting the wearer when he attempts to touch his hand to his face, eyes, nose, or mouth, comprising:
a sleeve worn over the elbow;
a position-sensing device attached to said sleeve; and
an alerting device coupled with said position-sensing device.

2. The apparatus of claim 1 wherein said sleeve is made of a flexible material.

3. The apparatus of claim 2 wherein said sleeve is made of an elastic material and conforms to the wearer's elbow.

4. The apparatus of claim 2 wherein said sleeve is lined with a soft fabric to improve the wearer's comfort.

5. The apparatus of claim 2 further comprising one or more fastening devices to adjust the fit of said sleeve to the wearer's elbow.

6. The apparatus of claim 1 wherein said position-sensing device detects changes in position of the wearer's arm and is triggered when the wearer raises his arm and places his hand near his face.

7. The apparatus of claim 1 wherein said alerting device alerts the wearer that his hand is approaching his face when activated by said position-sensing device.

8. The apparatus of claim 1 wherein said position-sensing and alerting devices are electrical devices.

9. The apparatus of claim 8 further comprising a power source for supplying current to said position-sensing and alerting devices.

10. The apparatus of claim 9 further comprising an on-off switch that allows the wearer to enable or disable the flow of current from said power source.

11. The apparatus of claim 9 further comprising a housing device containing said position-sensing device, said alerting device, and said power source wherein said housing device is attached to said sleeve.

12. An apparatus for preventing the spread of germs, disease, and infection by alerting the wearer when he attempts to touch his hand to his face, eyes, nose, or mouth, comprising a sleeve worn over the elbow, wherein said sleeve is made of a flexible material, either elastic and conforming to the wearer's elbow or adjustable comprising one or more fastening devices, lined with a soft fabric to improve the wearer's comfort; an electrical position-sensing device attached to said sleeve that detects when the wearer raises his arm and places his hand near his face; an electrical alerting device coupled with and activated by said position-sensing device that warns the wearer that his hand is approaching his face; a power source for providing current to said position-sensing and alerting devices; an on-off switch for enabling and disabling the flow of current from said power source; and a housing device attached to said sleeve that contains said position-sensing device, said alerting device, and said power source.
